(19) United States
(12) Patent Application Publication
(10) Pub. No.: US 2025/0171874 A1
(43) Pub. Date: May 29, 2025

(54) PRINCIPLES OF OPERATION AND CONTROL OF OXIDIZER IN COUNTERCURRENT LEACHING CONFIGURATIONS

(71) Applicant: University of Kentucky Research Foundation, Lexington, KY (US)

(72) Inventors: Joshua Werner, Lexington, KY (US); Peijia Lin, Hancock, MI (US)

(21) Appl. No.: 18/842,763

(22) PCT Filed: Mar. 1, 2023
(86) PCT No.: PCT/US23/14254

§ 371 Date: Aug. 29, 2024

Related U.S. Application Data
(60) Provisional application No. 63/315,322, filed on Mar. 1, 2022.
(60) Provisional application No. 63/398,695, filed on Aug. 17, 2022.
(60) Provisional application No. 63/447,313, filed on Feb. 21, 2023.

(51) Int. Cl. C22B 15/00; C22B 1/14; C22B 7/00; C22B 11/00

(52) U.S. Cl. CPC C22B 15/0078; C22B 1/14; C22B 7/008; C22B 11/04; C22B 15/0089

(57) ABSTRACT

A method and apparatus are presented for recovering a target metal from a feed material. The method includes: contacting the feed material with a lixiviant adapted to leach target metal from a feed material feed stream in a leaching circuit having a plurality of leaching vessels V1, V2, Vn in series, establishing a countercurrent flow in the leaching circuit by delivering feed material feed stream to leaching vessel V1 and moving the feed material feed stream through the leaching circuit in a first direction toward leaching vessel Vn and delivering the lixiviant to the leaching vessel Vn and moving the lixiviant through the leaching circuit in a second direction toward leaching vessel V1, determining, by a controller, a reagent consumption rate for each of the leaching vessels V1, V2, Vn so as to validate performance, minimize left over reagent discharged from leaching vessel V1 and maximize target metal recovery from leaching vessel Vn and recovering the target metal from the lixiviant.

### RELATED APPLICATION

This application claims priority to U.S. Provisional Patent Application Ser. No. 63/315,322 filed on Mar. 1, 2022, U.S. Provisional Patent Application No. 63/398,695 filed on Aug. 17, 2022, and U.S. Provisional Patent Application Ser. No. 63/447,313 filed on Feb. 21, 2023 which are hereby incorporated by reference in their entirety.

### TECHNICAL FIELD

This document relates generally to the extraction of copper, and/or gold and other elements of value from materials including, particularly E-waste materials, copper bearing end of life manufactured products, or ores by a method of specific control of the leaching circuit to allow adequate consumption of the reagent causing leaching and the recovery of metal from the feed material.

### BACKGROUND

For purposes of this document “waste materials” broadly refers to any waste materials potentially including valuable elements and, more particularly, metals that may be reclaimed and recycled. Thus, waste materials include E-waste materials, auto shred materials containing base and precious metals, communications equipment such as plated wave guides, mixed metal conductors or wires, and the like. For purposes of this document, E-waste materials means any such material comprised of at least copper and one precious metal.

This document describes a new and improved method for the enhanced recovery of copper, gold and other valuable metals and materials from waste materials in a more efficient and cost-effective manner by teaching novel techniques to controlling the oxidizer reagent in the leaching circuit. Note that oxidizer and reagent are used synonymously herein.

### SUMMARY

In accordance with the purposes and benefits set forth herein, a new and improved method is provided for recovering metals from waste materials. That method broadly comprises, consists essentially of or consists of the steps of: (a) contacting the feed material with a lixiviant adapted to leach the target metal from a feed material feed stream in a leaching circuit having a plurality of leaching vessels V₁, V₂, Vₙ in series, (b) establishing a countercurrent flow in the leaching circuit by delivering the feed material feed stream to the leaching vessel V₁ and moving the feed material feed stream through the leaching circuit in a first direction toward leaching vessel Vₙ and delivering the lixiviant to the leaching vessel Vₙ and moving the lixiviant through the leaching circuit in a second direction toward leaching vessel V₁; (c) determining, by setting which may be via a controller, a reagent consumption rate for each of the leaching vessels V₁, V₂, Vₙ so as to validate performance, minimize left over reagent discharged from leaching vessel V₁ and maximize target metal recovery from leaching vessel Vₙ and (d) recovering the target metal from the feed material into the lixiviant.

In one or more of the many possible embodiments of the method, the method further includes calculating, by the controller, the reagent consumption rate for each vessel V₁, V₂, Vₙ based upon a formula (C_{n,in}−C_{n,out})/C_{n,in}*100 where C_{n,in} is a concentration of the reagent entering the vessel and C_{n,out} is the concentration of the reagent leaving the vessel where n designates the n^{th} tank.

In one or more of the many possible embodiments of the method, the method includes one or both of (a) using an ammonia-based lixiviant and (b) using copper (II) (Cu(II)) as an oxidizer and component of the lixiviant. Those skilled in the art may recognize any number of oxidizers may be used such as hydrogen peroxide or metal species which has multiple valances which allow for stable ionic compounds in the lixiviant.

In at least some embodiments, the method may further include determining, by the controller via manipulating flow rates, a residence time for the feed material in each vessel V₁, V₂, Vₙ based upon (or required by) an average particle size of the feed material feed stream to reach certain recoveries.

In some embodiments, the method includes one or more of the following: (a) conducting the leaching under anaerobic conditions, (b) using electronic waste as the feed material (including ores) and selecting copper metal as the target metal, (c) using electrowinning in the recovering of the copper metal from the lixiviant, and (d) generating Cu(II) ions during electrowinning and using the generated Cu(II) ions as an oxidant for leaching the copper metal in the leaching circuit, and/or (e) using air or oxygen for regenerating Cu(II) ions.

In accordance with an additional aspect, an apparatus for recovering a target metal from a feed material, comprises, consists essentially of or consists of; (a) a leaching circuit having a plurality of leaching vessels V₁, V₂, Vₙ in series, and (b) a control module including (i) a metering system adapted for delivering the feed material feed stream to the leaching vessel V₁ and moving the feed material feed stream through the leaching circuit in a first direction toward leaching vessel V₁ and delivering a liquid phase, including an ammonia-based lixiviant and a Cu(II) reagent, to the leaching vessel V₁ and moving the liquid phase through the leaching circuit in a second direction toward leaching vessel V₁, (ii) at least one Cu(II) concentration monitor or sensor adapted for monitoring the concentration of Cu(II) in at least one of the leaching vessels V₁, V₂, Vₙ in the leaching circuit and collecting data respecting the concentration of Cu(II) in each of the leaching vessels V₁, V₂, Vₙ in the leaching circuit, and (iii) a controller adapted to receive the data from a singular or a plurality of Cu(II) concentration monitors and maintain the concentration of the copper II (Cu(II)) in the ammonia-based lixiviant in the leaching vessels V₁, V₂, Vₙ by changing the flow rate of the liquid phase, and/or the flow rate of the feed material feed stream to achieve metal removal from the feed material feed stream of between 1 and 50% in each vessel.

In at least some embodiments, the controller is further adapted to calculate the Cu(II) reagent consumption in each vessel V₁, V₂, Vₙ in accordance with a formula (C_{n,in}−C_{n,out})/C_{n,in}*100 where C_{n,in} is a concentration of the Cu(II) reagent entering the vessel and C_{n,out} is the concentration of the Cu(II) reagent leaving the vessel.

In at least some of the embodiments of the apparatus, the apparatus further includes a shredding device, adapted for shredding the feed material to an average particle size of less than 10 mm, upstream from the leaching vessel V₁. In at least some embodiments, the apparatus further includes an electrowinning device, adapted to recover copper metal from the ammonia-based lixiviant and generate Cu(II) ions for use as an oxidant for leaching the copper metal in the leaching circuit, downstream from leaching vessel V₁. In one or more of the embodiments, the leaching vessels V₁, V₂, and Vₙ are lamella clarifiers with agitation.

In the following description, there are shown and described several preferred embodiments of the method. As it should be realized, the method is capable of other, different embodiments and its several details are capable of modification in various, obvious aspects all without departing from the method as set forth and described in the following claims. Accordingly, the drawings and descriptions should be regarded as illustrative in nature and not as restrictive.

### BRIEF DESCRIPTION OF THE DRAWING FIGURES

The accompanying drawing figures incorporated herein and forming a part of the patent specification, illustrate several aspects of the method and one possible apparatus for performing the method and together with the description serve to explain certain principles thereof.

FIG. 1 is an Eh-pH diagram for a Cu—NH₃—H₂O system at 298° K.

FIG. 2 is schematic diagram of a copper recovery process using ammoniacal alkaline solutions.

FIG. 3 is a schematic illustration of the electrochemical-catalytic mechanism of thiosulfate leaching.

FIG. 4 is an Eh-pH diagram of the gold-thiosulfate-ammonia-water system at 25° C. wherein the activities of the species are 2.5×10⁻⁵ M Au (5 ppm), 0.2 M S₂O₃²⁻ and 0.4 M NH₃/NH₄⁺ [ΔG_{f}⁰(S₂O₃²⁻)=−518.8 kJ/mol].

FIG. 5 is a schematic diagram of one possible apparatus for performing the method.

FIG. 6 is a schematic cross-sectional view of a lamella clarifier useful in the present method.

FIG. 7 is a perspective view of the cross-sectioned lamella clarifier illustrated in FIG. 6.

FIG. 8 is a schematic cross-sectional illustration of three single stage lamella clarifiers of the type illustrated in FIGS. 6 and 7.

FIG. 9 is a conceptual flow sheet for a pilot plant incorporating ammoniacal chemistries.

FIG. 10 is a symbolic representation of the relative concentration of copper contained in solids versus the Cu(II) concentration (g/L).

FIG. 11 is a plot of Zhurvalev's linear expression ((1−α)^{-1/3}−1)² versus time under various initial CU(II) concentration (g/L).

FIG. 12 is a plot illustrating out-of-tank concentration (g/L) estimated by the justified model.

FIG. 13 is a plot of predicted reaction fraction (a) in each leaching stage under various initial Cu(II) concentrations by the justified model.

FIG. 14 is a plot of the accumulated reaction fraction (a) in the CCL circuit, predicted by the justified model.

FIG. 15 is a flowchart of kinetic modeling and simulation of countercurrent leaching.

FIG. 16 is a plot of Cu(II) concentration leaving each tank with 20 g/L Cu(II) feed.

FIG. 17 illustrates the orientation of lamella clarifiers (CCL 001 and CCL 002) in a manner to provide a variable residence time.

FIGS. 18a and 18b illustrate the results of the lamella clarifiers by varying the internal flow rate of the embodied circuit.

Reference will now be made in detail to the present preferred embodiments of the method, examples of which are illustrated in the accompanying drawing figures.

### DETAILED DESCRIPTION

### Theory of Ammonium Leaching for Base Metal (Cu)

$$2 Cu + {O}_{2} \to 2 CuO \qquad Equation 1$$

$$CuO + 2 NH 3 \cdot {H}_{2} O + 2 {NH}_{4}^{+} \to {Cu ( {NH}_{3} )}_{4}^{2 +} + 3 {H}_{2} O \qquad Equation 2$$

Chemical reactions—In ammonia leaching, ammonium salts (NH₄Cl or (NH₄)₂SO₄), and possible combinations of copper compounds such as CuSO₄, CuO, Cu₂O) combined with ammonia (NH₃ in forms of NH₄OH) are dissolved in water and used as the lixiviant. The dominant species in a Metal-NH₃—H₂O system are NH₃, NH₄⁺, H⁺, OH⁻ and corresponding anions. The corresponding metal species are complexed with the existing NH₃ and OH⁻ ions and corresponding anions. In an embodiment, the leaching of Cu by ammonia/ammonium solution can be divided into two steps: 1) the oxidation of Cu⁰ to Cu²⁺ by oxidant such as O₂, O2 via air, H₂O₂, or Fe³⁺, and the formation of CuO; 2) the dissolution of CuO in ammonia/ammonium solution and the generation of soluble copper-ammonia complex.

In the preferred embodiment, leaching of copper, and by extension other base metals. The major reactions are described as follows:

$${Cu ( {NH}_{3} )}_{4}^{2 +} + {e}^{-} = {Cu ( {NH}_{3} )}_{2}^{+} + 2 {NH}_{3} \qquad Equation 3$$

$${Cu ( {NH}_{3} )}_{2}^{-} + {e}^{-} = Cu + {e}^{-} = Cu + 2 {NH}_{3} \qquad Equation 4$$

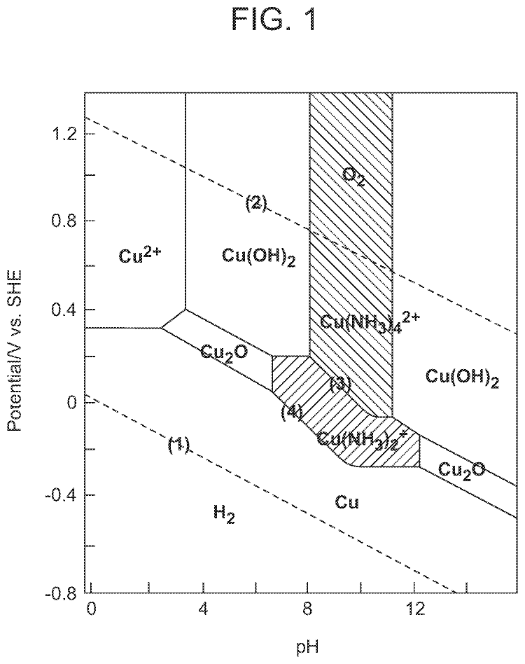

Eh-pH diagrams—The Eh-pH diagrams (Pourbaix diagrams) of Cu—NH₃—H₂O system are referenced from the existing literature in order to better illustrate the copper speciation in ammonia/ammonium matrix as shown in FIG. 1. According to this diagram, complexes of Cu⁺ and Cu²⁺ with NH₃ are stable ionic species in neutral and alkaline solutions. In the presence of NH₃, Cu⁺ and Cu²⁺ mainly exists as Cu(NH₃)₂⁺ and Cu(NH₃)₄²⁻ in the water stability zone (between two dash lines referenced as (1) for hydrogen evolution and (2) for oxygen evolution). This result indicates that Cu can be theoretically leached out in ammonia/ammonium solution (equation 4 indicated by (4) in FIG. 1) and stably remain in solution as complexes with NH₃. Additionally, the more positive oxidation-reduction potential (ORP) of Cu(NH₃)₄²⁺/Cu than Cu(NH₃)₂⁺/Cu indicates that Cu(NH₃)₄²⁺ can serve as an oxidant to oxidize Cu⁰ to Cu⁺/Cu²⁺ in ammonia/ammonium alkaline solution (equation 3 indicated by (3) in FIG. 1).

### Theory of Electrowinning in Ammonium Alkaline Solutions

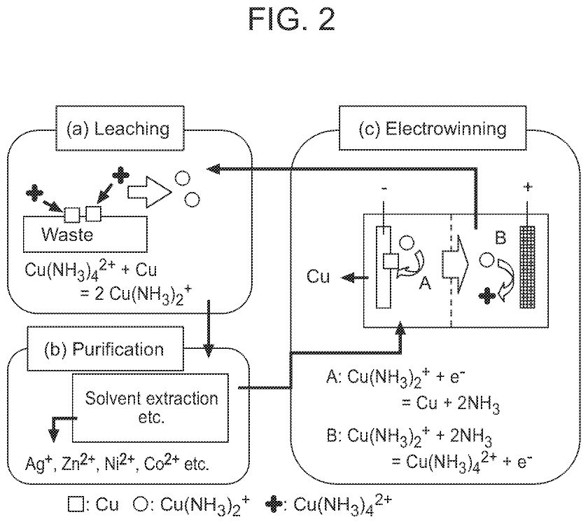

Chemical reactions—After the leaching stage, where copper is leached out as divalent ions in ammonia/ammonium solution, contaminant ions in the solution may be extracted via solvent extraction. The purified electrolyte is conveyed to the electrowinning stage. Such a copper recovery process is schematically illustrated in FIG. 2. The cathodic and anodic reaction in copper electrowinning are described by the following equations:

$${Cu ( {NH}_{3} )}_{2}^{-} + {e}^{-} = Cu + 2 {NH}_{3} , See Figure 1 , ( 4 ) for \\ corresponding interface \qquad Equation 5$$

$${Cu ( {NH}_{3} )}_{4}^{2 +} + {e}^{-} = {Cu ( {NH}_{3} )}_{2}^{+} + 2 {NH}_{3} , See Figure 1 , ( 3 ) for \\ corresponding interface \qquad Equation 6$$

Reaction mechanism—In an embodiment of the leaching process, electronic wastes are leached in the ammonium solution containing Cu(NH₃)₄²⁺ ions (Cu²⁺), and the metallic copper (Cu⁰) in the wastes reacts with the Cu²⁺ and is dissolved as Cu(NH₃)₂⁺ ions (Cu⁺) through the oxidation process described in equations 5 and 6. In the following solvent extraction process, the other base metals or undesired impurities such as iron, aluminum, nickel, cobalt and zinc (tri and divalent ions), can be separated using a selective extractant in ways known in the art. In this embodiment, the electrowinning stage, high purity Cu⁰ is obtained on the cathode from the Cu⁺/Cu²⁺ containing solution. Simultaneously, Cu⁺ is oxidized to Cu²⁺ on the anode and the produced Cu²⁺ is recycled back in the leaching stage as the oxidizing reagent.

### Ammonium Thiosulfate Leaching for the Noble Metal (Au)

Chemical reactions—In thiosulfate leaching for gold, the formation of gold thiosulfate complex proceeds via the catalytic oxidation reaction with Cu(NH₃)₄²⁺ acting as the primary oxidant. This process can be divided into two steps: 1) the oxidation of Au⁰ to Au⁺ in forms of Au(NH₃)₂⁺ under the oxidative environment provided by the presence of Cu(NH₃)₄²⁺, which is also a product from the previous copper ammonia leaching process; 2) the Au(NH₃)₂⁺ complex further reacts with S₂O₃²⁻ ion in the solution and forms stable Au(S₂O₃)₂³⁻ specie. The reactions are as follows:

$${Au}^{0} + {Cu ( {NH}_{3} )}_{4}^{2 +} + 3 {S}_{2} {O}_{3}^{2 -} \to {Au ( {NH}_{3} )}_{2}^{+} + {Cu ( {S}_{2} {O}_{3} )}_{3}^{5 -} + 2 {NH}_{3} \qquad Equation 7$$

$${Au ( {NH}_{3} )}_{2}^{+} + 2 {S}_{2} {O}_{3}^{2 -} \to {Au ( {S}_{2} {O}_{3} )}_{2}^{3 -} + 2 {NH}_{3} \qquad Equation 8$$

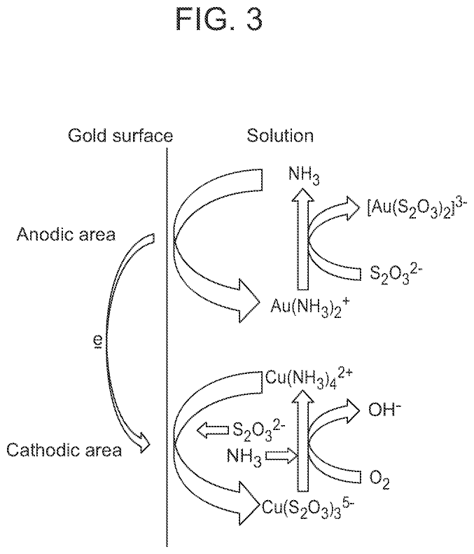

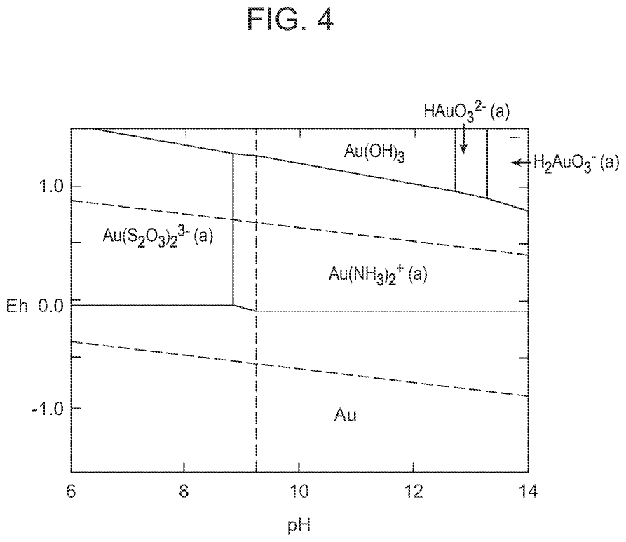

A schematic of the mechanism of gold thiosulfate leaching is shown in FIG. 3. FIG. 4 shows that the gold-ammonia complex appears next to the stability region of gold-thiosulfate complex. The gold-thiosulfate complex (Au(S₂O₃)³⁻) is more stable below pH 9 whereas the gold-ammonia complex (Au(NH₃)₂⁺) is dominant at pH greater than 9. With the manipulation of pH, it is possible to leach gold using thiosulfate solution in the presence of copper-ammonia complex as catalyst, based on Equation 7 and Equation 8.

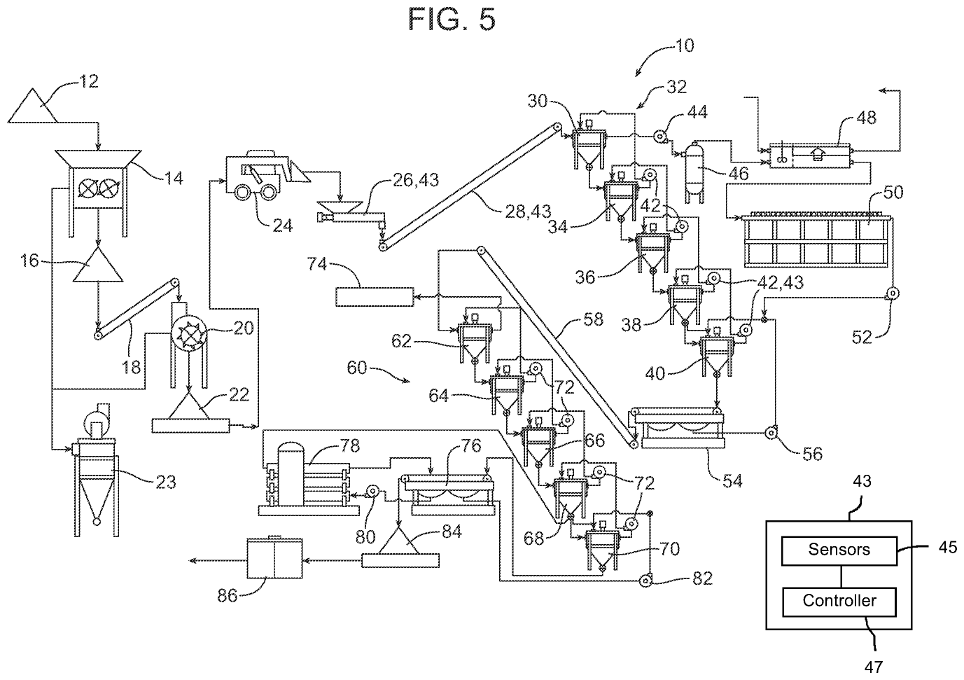

Reference is now made to FIG. 5 which schematically illustrates an apparatus 10 for conducting the new and improved method for recovering valuable metals, such as copper and gold, from waste materials and particularly E-waste materials. As illustrated, waste materials 12, may be fed into a coarse shredder 14 of a type known in the art to be useful for the coarse shredding of such materials. The coarse shredded waste materials 16 are then fed by a conveyor 18 or other means to a fine shredder 20 of a type known in the art for the fine shredding of such materials. In one possible embodiment, the E-waste materials are shredded to a size of between about 0.010 mm and about 10 mm. Any dust that might be generated during the shredding process may be collected at the cyclone 23 which may be leached or separated.

Next, the fine shredded waste materials 22 are transferred by a skid steer 24 or other means to a metered feeder 26 of a type known in the art to be useful for the metered feeding of such materials. The metered E-waste material may then be transferred by a conveyor 28 or other useful means to the first reactor vessel or unit 30 of a first leaching circuit, generally designated as 32.

In the illustrated embodiment, the first leaching circuit 32 includes a total of five reactor vessels designated 30, 34, 36, 38 and 40 that are connected in series and form a counter current leaching arrangement. The waste material feed stream delivered to the first unit 30 is contacted with a first lixiviant in the units 30, 34, 36, 38 and 40 of the first leaching circuit 32. That first lixiviant is particularly adapted to leach copper metal and other base metals from the waste material feed stream while leaving any noble metals behind in the treated waste material feed stream that is ultimately discharged from the first leaching circuit 32.

In one particularly useful embodiment, the E-waste material feed stream is subjected to ammonia leaching in the first leaching circuit 32 in order to leach the copper and the other base metals from the waste material feed stream. As noted above, ammonia leaching uses ammonium salts (NH₄Cl or (NH₄)₂SO₄) combined with ammonia (NH₃ in form of NH₄OH) dissolved in deionized water.

As should be appreciated, the waste material feed stream travels in a first direction through the first leaching circuit 32 from the first reactor vessel 30, to the second reactor vessel 34, then to the third reactor vessel 36, then to the fourth reactor vessel 38 and then finally to the fifth reactor vessel 40. The first ammonia-based lixiviant travels in a second opposite direction in a countercurrent flow to the waste material feed stream from the fifth reactor vessel 40, to the fourth reactor vessel 38, then to the third reactor vessel 36, then to the second reactor vessel 34 and then finally to the first reactor vessel 30. The various pumps 42 move the first ammonia-based lixiviant through the reactor vessels 40, 38, 36, 34 and 30 of the first leaching circuit 32. The first ammonia-based lixiviant is first transferred from the first reactor vessel 30 by the pump 44 to a filter 46 which captures any remaining particles of the waste material feed stream. The filtered first lixiviant is then transferred to a solvent extraction circuit 48 of a type known in the art, that is adapted to remove base metals other than copper from the first lixiviant. Those other base metals include, but are not necessarily limited to, iron, nickel, chromium, silver, zinc, cobalt and the like.

The treated first ammonia-based lixiviant with the copper ions retained and the other base metal ions extracted is then transferred to an electrowinning press 50 of the type disclosed in, for example, International Application Publication number WO2021/159086 (the full disclosure of which is incorporated herein by reference) filed concurrently herewith and entitled Electrowinning Cells for The Segregation of the Cathodic and Anodic Compartments. There, copper metal is recovered from the first ammonia-based lixiviant on the cathodes of the electrowinning cells making up the electrowinning press.

During the electrowinning process, Cu²⁺ ions are generated in the first lixiviant. These Cu²⁺ ions are used as an oxidant in the leaching of the copper and the other base metals from the waste material feed stream in the first leaching circuit. The first lixiviant, minus the now recovered copper metal and plus the Cu²⁺ ions generated during electrowinning is returned to the reactor vessel 40 of the first leaching circuit 32 by the pump 52. Preferably, the Cu²⁺ ion concentration in the first lixiviant of the first leaching circuit 32 is maintained between about 0.0001 M and about 1.6 M to enhance the leaching efficiency of the first circuit. The Cu²⁺ ion concentration may be adjusted by controlling the rate of the metered feeding of waste material to the first circuit, the lixiviant flow rate, between stage solid transfer rate or the current in the electrowinning cell 32.

The treated waste material feed stream is delivered from the last reactor vessel 40 of the first leaching circuit 32 to a belt filter wash (or other solid/liquid separators and conveyances of a type known in the art) 54 where the majority of the first lixiviant remaining on the treated E-waste stream is recovered and returned by the pump 56 to the unit 40 of the first leaching circuit 32.

The treated E-waste feed stream with some remaining first lixiviant, including Cu²⁺ ions, is then transferred by the conveyor 58 to the second leaching circuit generally designated by reference numeral 60 where it is contacted with a second lixiviant. The Cu²⁺ ion concentration in the second lixiviant is preferably maintained between about 0.0001 M and about 0.1 M in the second lixiviant in order to provide sufficient oxidization to efficiently leach the at least one noble metal from the treated waste material stream. If desired, additional oxidizer for leaching may be provided by sparging oxygen through the second lixiviant.

In the illustrated embodiment, the second leaching circuit includes five reactor vessels or units 62, 64, 66, 68 and 70 connected in series. The treated E-waste material feed stream delivered to the second leaching circuit 60 is contacted with a second lixiviant in the units 62, 64, 66, 68 and 70. The second lixiviant is particularly adapted to recover at least one noble metal from the treated E-waste feed stream. For purposes of this document, “noble metals” include silver, platinum, palladium and gold.

In one particularly useful embodiment of the method, the method uses thiosulfate leaching to leach the noble metals from the treated waste material feed stream in the second leaching circuit 60. As noted above, the Cu²⁺ ions in any remaining first lixiviant on the treated waste material feed stream transferred to the second leaching circuit 60 acts as a primary oxidizer to catalyze the leaching of the at least one noble metal, and, more particularly, the gold from the treated E-waste feed stream.

As should be appreciated, the treated waste material feed stream travels in a third direction through the second leaching circuit 60 from the first reactor vessel 62, to the second reactor vessel 64, then to the third reactor vessel 66, then to the fourth reactor vessel 68 and then finally to the fifth reactor vessel 70. The second lixiviant travels in a fourth direction in a countercurrent flow to the treated waste material feed stream from the fifth reactor vessel 70, to the fourth reactor vessel 68, then to the third reactor vessel 66, then to the second reactor vessel 64 and then finally to the first reactor vessel 62. The various pumps 72 move the second lixiviant through the reactor vessels 70, 68, 66, 64 and 62 of the second leaching circuit 60. The second lixiviant is then transferred from the first reactor vessel 62 by a pump or other appropriate device (not shown) to a Merrill Crowe plant 74 wherein a precipitation reaction of a type known in the art is used to recover the noble metal, and, more particularly, the gold from the second lixiviant.

In an embodiment the treated waste material feed stream exiting the second leaching circuit 60 at the fifth reactor vessel 70 is delivered to a belt filter and washing station 76 and a reverse osmosis unit 78 where all the reagents including the second lixiviant are washed from the treated waste material feed stream, recovered and then returned to the fifth reactor vessel 70 by the pumps 80 and 82. The now washed and treated waste material feed stream 84 may then be dried in an oven 86 with the tails deposed of in a suitable and ecologically sound manner or readied for further processing.

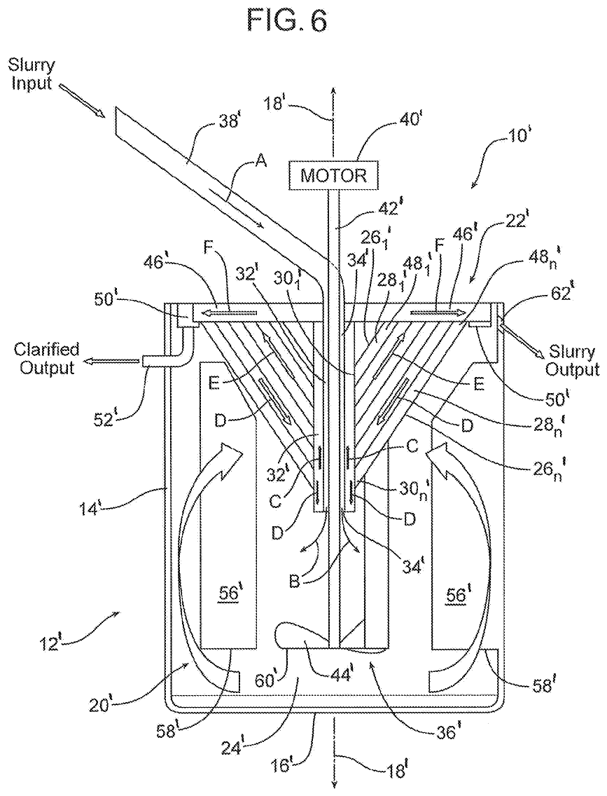

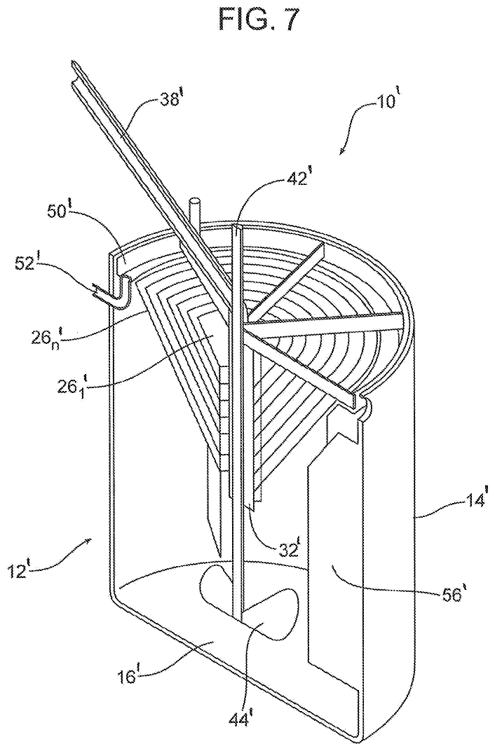

Any or all of the reactor vessels 30, 34, 36, 38, 40, 62, 64, 66, 68 and 70 may take the form of the agitated lamella clarifier 10′ illustrated in FIGS. 6 and 7 which is particularly well adapted for leaching, adsorption and clarification applications, including, for example, separating leachate from a slurry. As illustrated, the lamella clarifier 10′ includes a housing, generally designated by reference numeral 12′, having a circular sidewall 14′, a bottom wall 16′ and a center axis 18′. The single stage clarifier mixing assembly 10′ also includes a mixing section 20′ and a clarifier section 22′ both held within the housing 12′. More particularly, the mixing section 20′ includes a mixing chamber 24′ within the circular sidewall 14′ and adjacent the bottom wall 16′.

The clarifier section 22′ overlies and is axially aligned with the mixing section 20′ along the center axis 18′ within the housing 12′. As illustrated, the clarifier section 22′ includes a plurality of plates 26₁′-26ₙ′ that are nested together and define a plurality of intervening flow passageways 28₁′-28ₙ′. In the illustrated embodiment, the plates 26₁′-26ₙ′ are frustoconical in shape. Such a shape may be approximated by interconnecting a series of flat plates if desired. The lowermost ends 30₁′-30ₙ′ of the respecting intervening flow passageways 28₁′-28ₙ′ open into an axial passageway 32′ that extends through the clarifier section 22′ along and concentrically around the center axis 18′.

The single stage clarifier mixing assembly 10′ also includes an inlet 34′ adapted for delivering an inlet stream to the mixing section 20′ and, more particularly, the mixing chamber 24′. For purposes of this document, the terminology “inlet stream” refers to a liquid or slurry to be processed through the mixing assembly.

The single stage clarifier mixing assembly 10′ also includes an agitator, generally designated by reference numeral 36′, that is adapted to mixing the inlet stream in the mixing chamber 24′. The single stage clarifier mixing assembly 10′ also includes an inlet stream feed conduit 38′ that extends along the center axis 18′ through the axial passageway 32′ to the inlet 34′. As will be described in greater detail below, the inlet stream is fed through the feed conduit 38′ to the inlet 34′ where that inlet stream is delivered to the mixing chamber 24′ of the mixing section 20′.

The agitator 36′ of the illustrated embodiment includes a drive motor 40′ connected by a drive shaft 42′ to an impeller 44′ which, in the illustrated embodiment, is provided at the distal end of the drive shaft. As illustrated, the drive shaft 42′ extends along the center axis 18′ through the feed conduit 38′ and the inlet 34′. Thus, it should be appreciated that the feed conduit 38′ and inlet 34′ are concentrically disposed around the drive shaft 42′; the axial passageway 32′ is concentrically disposed about the feed conduit 38 and the inlet 34′; and the lowermost ends 30₁′-30n′ of the respective intervening flow passageways 28₁′-28ₙ′ and the lowermost ends of the frustoconical plates 26₁′-26ₙ′ are concentrically disposed about the axial passageway 32′.

As further illustrated in FIGS. 6 and 7, the clarifier section 22′ also includes a clarified liquid chamber 46′ overlying the uppermost ends 48₁′-48ₙ′ of the intervening flow passageways 28₁′-28ₙ′ as well as the uppermost ends of the frustoconical plates 26₁′-26ₙ′. As should be appreciated, the uppermost ends 48₁′-48ₙ′ of the intervening flow passageways 28₁′-28ₙ′ open into the clarified liquid chamber 46′.

The clarifier section 22′ also includes a clarified liquid flow gutter 50′ (i.e. overflow weir) that extends concentrically around the clarifier liquid chamber 46′ and functions to feed clarified leachate to the first outlet 52′ that extends from the bottom wall of the clarified liquid flow gutter 50′ through the circular sidewall 14′ of the housing 12′. A first outlet stream is discharged from the first outlet. Depending upon the particular application, the “first outlet stream” may comprise a clarified liquid, a clarified leachate, or clarified barren solution.

As still further shown in FIGS. 6 and 7, the mixing section 20′ includes a plurality of baffles or vanes 56′ extending radially inwardly from the circular sidewall 14′ toward the agitator 36′ and, more particularly, the impeller 44′. Those vanes 56′ may be positioned at angularly spaced positions such as, for example, every 60 degrees. As further illustrated in FIGS. 6 and 7, the bottoms 58′ of the vanes 56′ may be provided at the same height as the bottom 60′ of the impeller 44′ from the bottom wall 16′. The baffles or vanes 56′ prevent the solution from spinning so as to promote agitation and mixing.

In addition, the mixing section 20′ includes a second outlet 62′ provided in circular sidewall 14′ outboard of the clarifier section 22′ at a vertical position substantially corresponding to the clarified liquid flow gutter 50′: that is, substantially corresponding to the top of the frustoconical plates 26₁′-28ₙ′. A second outlet stream is discharged from the second outlet 62′. Depending upon the particular application, the second outlet stream may comprise a concentrated-solids slurry or a slurry of the same concentration as the mixing chamber 24′.

In operation, an inlet stream, such as a slurry, is delivered to the single stage clarifier mixing assembly 10′ by means of the feed conduit 38′ (note action arrow A). The inlet stream passing through the feed conduit 38′ is discharged from the inlet 34′ into the mixing chamber 24′ of the mixing section 20′ (note action arrows B). The agitator 36′ turns with the necessary rotational speed to mix the inlet stream (e.g. slurry) in the mixing chamber 24′ and maintain the slurry in suspension. The strongest mixing action is provided at the very bottom of the mixing chamber 24′ adjacent the bottom wall 16′ below the bottoms 58′ of the vanes 56′. As the liquid flow is not all exiting via 62′, the inlet stream rises in the housing 12′, the inlet stream passes through the axial passageway 32 through the lowermost ends 30₁′-30ₙ′ and fills the respective intervening flow passageways 28₁′-28ₙ′ defined between the frustoconical plates 26₁′-26ₙ′ (note action arrows C).

It is in these intervening flow passageways 28₁′-28ₙ′ that lamella separation occurs and solids from the inlet stream (e.g. slurry) flow downward (note action arrows D) in the intervening flow passageways 28₁′-28ₙ′ on the upper faces of the frustoconical plates 26₁′-26ₙ′ under the force of gravity while clarified liquid from the inlet stream flows upward (note action arrows E) and is pushed into the clarified liquid chamber 46′ through the uppermost ends 48₁′-48ₙ′ of the intervening flow passageways. The resulting clarified liquid (a.k.a. first outlet stream) flows outward (note action arrows F) in the clarified liquid chamber 46′ into the clarified liquid flow gutter 50′ and is subsequently discharged through the first outlet 52′. In contrast, a second outlet stream with concentrated solids is simultaneously forced outward at the top of the mixing chamber 24′ through the second outlet 62′.

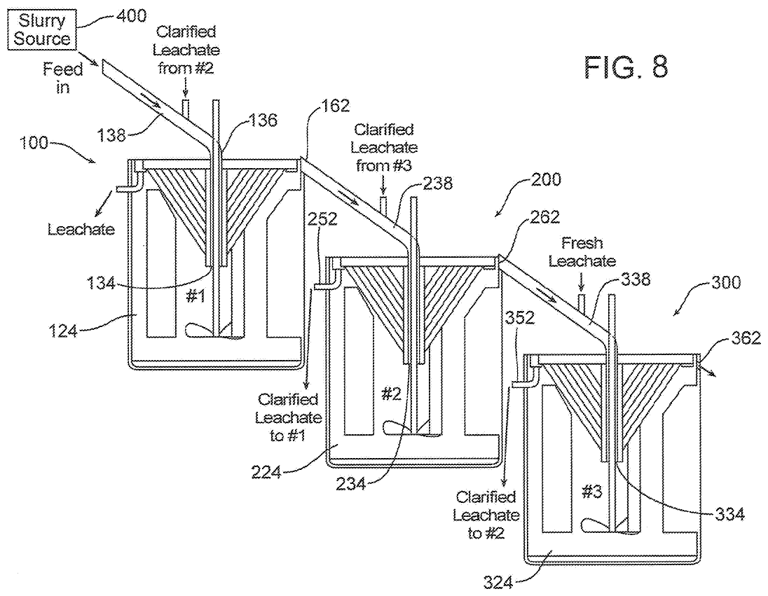

Reference is now made to FIG. 8 illustrating a first lamella clarifier 100, a second lamella clarifier 200 and a third lamella clarifier 300. All three of the lamella clarifiers 100, 200, 300 have a structure corresponding to the lamella clarifier 10′ illustrated in FIGS. 6 and 7. Together, the three lamella clarifiers 100, 200, 300 illustrated in FIG. 8 function as a countercurrent leaching circuit. As illustrated, the first outlet stream or clarified leachate discharged from the first or clarified leachate outlet 252 of the second lamella clarifier 200 is delivered to the mixing chamber 124 of the first lamella clarifier 100 through the feed conduit 138 and inlet 134. At the same time, the first outlet stream or clarified leachate from the first or clarified leachate outlet 352 of the third lamella clarifier 300 is delivered to the mixing chamber 224 of the second lamella clarifier 200 through the feed conduit 238 and inlet 234.

In addition, the second outlet stream or slurry from the second outlet 162 of the first lamella clarifier 100 is delivered to the mixing chamber 224 of the second single stage clarifier mixing assembly 200 through the feed conduit 238 and the inlet 234 and the second outlet stream or slurry from the second outlet 262 of the second lamella clarifier 200 is delivered to the mixing chamber 324 of the third lamella clarifier 300 through the feed conduit 338 and the inlet 334. Of course, the inlet stream, fresh leachate or unprocessed slurry is also being fed from a source 400 into the mixing chamber 124 of the first lamella clarifier 100 through the feed conduit 38 and inlet 134 while processed slurry being discharged from the outlet 362 of the third lamella clarifier 300 is being discharged from the system.

As should be appreciated, the plurality of frustoconical plates 26₁′-26ₙ′ in the various lamella clarifiers 10, 100, 200, 300 are arranged so as to allow for an increase of inter-lamella area as the radius of the plates increases. The effect of this increase in inter-lamella area is that the mean stream velocity of the inlet stream or slurry in the lamella clarifier decreases with increasing radius. As the mean stream velocity of the inlet stream or slurry decreases, the settling efficiency of the solids improves as a function of radius.

While the previous description refers to separations of solid from a slurry it should be appreciated that the lamella clarifiers 10′, 100, 200, 300 disclosed above may not only be used in liquid-solid separations, but also for purposes of liquid-liquid separation as well as part of solid-liquid reactors and liquid-liquid reactors.

The plurality of frustoconical plates 26₁′-26ₙ′ and the plurality of intervening flow passageways 28₁′-28ₙ′ defined between those plates may be oriented at an angle of between 15 and about 60 with respect to the center line axis 18′ which extends in a vertical direction. In one particularly useful embodiment, the angle of the plurality of frustoconical plates 26₁′-26ₙ′ and plurality of intervening flow passageways 28₁′-28ₙ′ is approximately 35 degrees.

The above description may be said to relate to an apparatus 10 for recovering a target metal from a feed material. The apparatus may be described as including; (a) a leaching circuit, such as shown at 32, having a plurality of leaching vessels, 30, 34, 36, 38 and 40 in series (and also referenced by the designation V₁, V₂, . . . Vₙ), and (b) a control module 43 including (i) a metering system 26, 28 (including pumps 42) adapted for delivering the feed material feed stream to the leaching vessel V₁ and moving the feed material feed stream through the leaching circuit in a first direction toward leaching vessel Vₙ and delivering a liquid phase, including an ammonia-based lixiviant and a Cu(II) reagent, to the leaching vessel Vₙ and moving the liquid phase through the leaching circuit in a second direction toward leaching vessel V₁, (ii) a plurality of Cu(II) concentration monitors or sensors 45, of a type known in the art, adapted for monitoring or sensing the concentration of Cu(II) in each of the leaching vessels V₁, V₂, Vₙ in the leaching circuit and collecting data respecting the concentration of Cu(II) in each of the leaching vessels V₁, V₂, Vₙ in the leaching circuit, and (iii) a controller 47 adapted to receive the data from the plurality of Cu(II) concentration monitors/sensors and maintain the concentration of the copper II (Cu(II)) in the ammonia-based lixiviant in the leaching vessels V₁, V₂, Vₙ by changing the flow rate of the liquid phase (by controlling operation of the pumps 42), and/or the flow rate of the feed material feed stream (by controlling operation of the metered feeder 26 and the conveyor 28) to achieve metal removal from the feed material feed stream of between 1 and 50% in each vessel.

In some particularly useful embodiments, the controller 47 is further adapted to calculate the Cu(II) reagent consumption in each vessel V₁, V₂, Vₙ in accordance with a formula (C_{n,in}−C_{n,out})/C_{n,in}*100 where C_{n,in}, is a concentration of the Cu(II) reagent entering the vessel and C_{n,out} is the concentration of the Cu(II) reagent leaving the vessel.

Such an apparatus may be said to relate to a method for recovering a target metal from a feed material. That method broadly comprises the steps of: (a) contacting the feed material with a lixiviant adapted to leach the target metal from a feed material feed stream in a leaching circuit, as described above, having a plurality of leaching vessels V₁, V₂, Vₙ in series, (b) establishing a countercurrent flow in the leaching circuit by delivering the feed material feed stream to the leaching vessel V₁ and moving the feed material feed stream through the leaching circuit in a first direction toward leaching vessel Vₙ and delivering the lixiviant to the leaching vessel Vₙ and moving the lixiviant through the leaching circuit in a second direction toward leaching vessel V₁, (c) determining, by a controller, a reagent consumption rate for each of the leaching vessels V₁, V₂, Vₙ so as to validate performance, minimize left over reagent discharged from leaching vessel V₁ and maximize target metal recovery from leaching vessel Vₙ and (d) recovering the target metal from the lixiviant.

The method may further include calculating, by the controller, the reagent consumption rate for each vessel V₁, V₂, Vₙ based upon a formula (C_{n,in}−C_{n,out})/C_{n,in}*100 where C_{n,in} is a concentration of the reagent entering the vessel and C_{n,out} is the concentration of the reagent leaving the vessel. Still further, the method may include using an ammonia-based lixiviant. Alternatively or in addition, the method may include using copper (II) (Cu(II)) as an oxidizer and the reagent. Those skilled in the art will recognize any number of oxidizers may be used such as hydrogen peroxide or metal species which has multiple valances which allow for stable ionic compounds in the lixiviant.

The method may include determining, by the controller, a residence time for the feed material feed stream in each vessel V₁, V₂, Vₙ based upon an average particle size of the feed material feed stream.

In some embodiments, the method includes one or more of the following: (a) conducting the leaching under anaerobic conditions, (b) using electronic waste as the feed material and selecting copper metal as the target metal, (c) using electrowinning in the recovering of the copper metal from the lixiviant, and (d) generating Cu(II) ions during electrowinning and using the generated Cu(II) ions as an oxidant for leaching the copper metal in the leaching circuit.

### Experimental Section

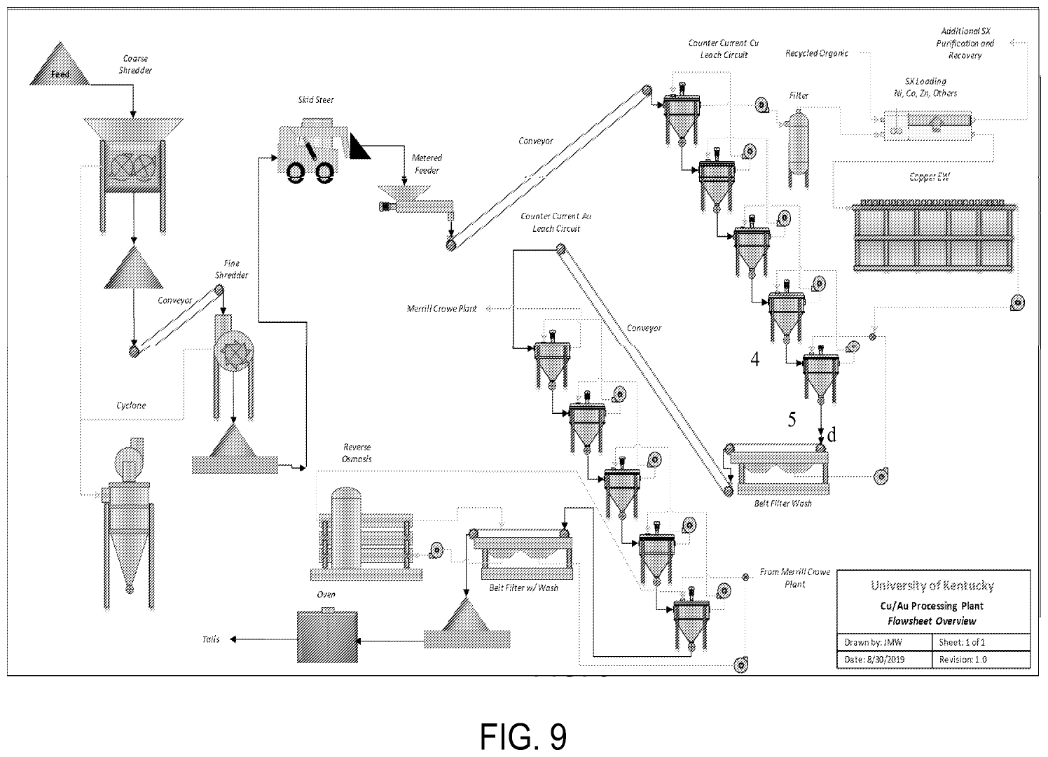

In view of the previous embodiments and descriptions an additional embodiment is provided to describe the conceptual operation of the copper leaching circuits described in FIGS. 5 and 9 which describe a multiplicity of leaching vessels arranged in such a manner as the solids containing or comprised of copper flow in opposite direction to the lixiviant. FIG. 9 shows 5 leaching vessels (1,2,3,4,5) arranged in counter flow arrangement, however, there may be more, or less as determined by processing requirements. Those skilled in the art will recognize that FIG. 9 represents a combination leaching and solid/liquid separation vessel. Those skilled in the art will also recognize that there is a multiplicity of methods available to achieve counterflow leaching arrangements such as utilizing distinct leaching and separation vessels.

In this embodiment material suitable for leaching is added to leaching vessel number 1. A possible example of the electro-oxidizing species is Cu(NH₃)₄²⁻ ions (Cu(II)). In leach vessel 1, which receives unleached material (represented in FIG. 9 point a), the lixiviant containing the electro-oxidizing species has previously been in contact with material containing the desired elements, or element. The embodiment depicted shows, but is not limited to ammoniacal solutions as a lixiviant, elements is which may be extracted are Cu, Ni, Co, Zn, or any material which forms a stable amine complex.

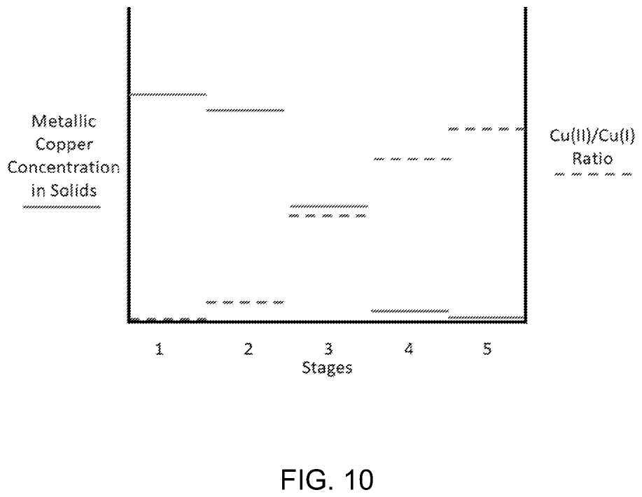

In this embodiment it is assumed that copper is the primary species of interest in the leaching circuit. As such, FIG. 10. is included to show the interaction of the copper found in solids to be leached vs. the Cu(II)/Cu(I) ratio of the lixiviant by stage. FIG. 10 stage 1 shows the maximum possible copper concentration and the lowest possible Cu(II)/Cu(I) ratio. The pregnant leaching solution is shown being removed in FIG. 9 point b and proceeding to further processing. In an embodiment this may be electrowinning. In another embodiment this may be solvent extraction. In yet another embodiment it may be a combination of solvent extraction and electrowinning. In either of these several embodiments it is desirable to reduce the Cu(II) species as far as possible and practical to Cu(I). As an example, the reduction to metallic copper at the cathode in the electrowinning cell, operational efficiencies would be increased by minimizing the amount of Cu(II) reporting to the cathode provided any Cu(II) passed through the solvent extraction stage. As an example, a solvent with an affinity for 2+ valance ions will extract less copper into the recovery stream. For this reason, stage 1 of leaching is operated in such a manner as there exists an excess of species to be oxidized (in this embodiment copper) and the lowest possible concentration of oxidizing species. Operation in this manner allows for a processing buffer should system disturbances move the process away from an ideal steady state condition.

As shown in FIG. 10, stage 2 shows a slight decrease in copper concentration from stage 1 owing to the low amount of oxidizer available. As solids progress through the leaching circuit more oxidizer becomes available with less copper, until in the last stage, the copper has reached its lowest possible concentration in solids. It is anticipated that both the copper and Cu(II)/Cu(I) ratio will exhibit some type of curve as solids or liquids proceed through the circuit. This is intentional and is shown symbolically in FIG. 10. The low change in concentration in the final or starting stages represents either an overabundance or a lack of specific reagent, or product whichever the case may be. This is ideal to improve recoveries and efficiencies of the overall process.

In this embodiment, electrolyte with a higher Cu(II)/Cu(I) ratio than that exiting the leaching circuit shown in FIG. 9 point b is reintroduced to the leaching circuit as shown in FIG. 9 point c after reacting in the electrowinning cell. Material which has been leached is removed (FIG. 5 point d) to a solid/liquid separator, which in this embodiment is shown to be a belt filter.

In an embodiment, the Cu(II) concentration may be used interchangeably with the Cu(II)/Cu(I) ratio as a substitute.

To provide a nonlimiting example of the design of such as circuit as described in the previous embodiment, the following example is provided to show how one skilled in the art may utilize such principles to design and operate such a circuit. An assumption in a continuously stirred tank reactor (CSTR) of which the described lamella clarifiers herein may be considered a subset, is that the concentration of reagents of importance (in this embodiment Cu(II)) in each individual leaching tank may be considered as constant within a tank. In a counter current leaching (CCL) circuit the concentration existing in each tank is different (as described conceptually in FIG. 10), thus varying the performance of Cu leaching in each leaching tank relating the varying rate of metal recovery. In other words, the predicted leaching, assuming a constant concentration mechanism, differed from tank to tank with a different starting reagent concentration defined as C₀. Thus, the various starting C₀ in each tank therefore results in a different leaching rate in each tank.

For those skilled in the art to design or operate a leaching circuit as described in the previous embodiments the following principles maybe considered with the following approximations:

1) The concentration in a leaching vessel is considered constant, due to the stirring and assumed ideal mass transfer in tanks.

2) A leaching model indicative of the leaching performance of an individual tank relating to important leaching parameters is identified and utilized. Such parameters considered by the model may be, reagent concentration (in this embodiment Cu(II)), particle size, temperature, etc. which is suitable under a constant concentration of reagent to indicate leaching of performance. This may also be measured practically in situ via Cu(II) measurement or sampling to forgo a leaching model.

3) The circuit is operated in such a manner to minimize the regent leaving the leaching circuit and maximizing the recovery of the metal of interest from the feed material.

To provide a nonlimiting example of utilizing these principles, the following is provided. In consideration of developing a model which describes the leaching behavior or electronic waste, a leaching test was conducted with processed E-Waste of a particular size. A set of leaching experiments were performed where the concentration of Cu(II) was set at the beginning of the experiment and decreased with time. A shrinking core model with a variable concentration is given by Zhuravlev's (Zhuravlev, V. F., Lesokhin, I. G., & Tempelman, R. G. (1948). Kinetics of Reactions in the Formation of Aluminates and the Contribution of Mineralizers to the Process. J. Appl. Chem. USSR, 21(09), 887-890.) changing concentration model, defined as:

$${( {( 1 - α )}^{- \frac{1}{3}} - 1 )}^{2} = \frac{2 D {V}_{m} {C}_{0}}{{r}_{0}^{2}} t = {k}_{z}^{′} t$$

Where α is the reacted fraction of Cu; D is the diffusion coefficient, m²/s; Vₘ is the volume of product formed from 1 mole of the slowest penetrating component; C₀ is the initial concentration of reactant, mol/L. Since the concentration C₀ in each leaching tank is different the rate constant becomes:

$${k}_{x}^{′} = \frac{2 D {V}_{m} {C}_{0}}{{r}_{0}^{2}} = b \times {C}_{0}$$

where b is the model-conversion constant written as

$$b = \frac{2 D {V}_{m}}{{r}_{0}^{2}} ;$$

C₀ is the initial Cu concentration coming in the reaction tank, in g/L.

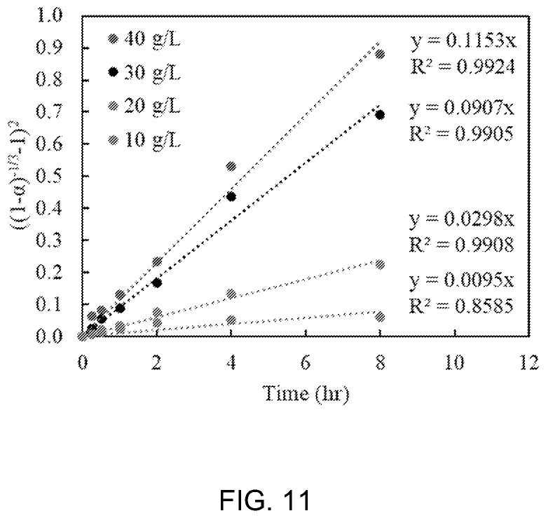

Referring back to the fitting of Zhuravlev's model using batch experimental data under various Cu(II) concentrations, as presented in FIG. 11. The model-conversion constant b in linear relationship of rate constant k (as indicated by the slopes in FIG. 11) across four different concentrations (10, 20, 30, 40 g/L) was obtained. As shown in Table, by minimizing the sum of error between fitted k values and predicted k values applying Excel Solver, solved value for constant b is 0.002882.

TABLE A
Sum of error minimization between model-
fitted k values and calculated k values.

| Cu(II) conc. (g/L) | k (experimental) | k (calculated) | Error |
|---|---|---|---|
| 40 | 0.1153 | 0.1153 | 0.0000 |
| 30 | 0.0907 | 0.0865 | 0.0042 |
| 20 | 0.0298 | 0.0576 | 0.0278 |
| 10 | 0.0095 | 0.0288 | 0.0193 |
| Constant b | 0.002882 | Sum of Error | 0.0514 |

Correspondingly, a justified model for leaching under constant concentration, was developed by adopting the interchangeable k value from Zhuravlev's changing-concentration model into Jander's constant-concentration model (Jander, 1927):

$${( 1 - {( 1 - α )}^{\frac{1}{3}} )}^{2} = \frac{2 D {V}_{m} {C}_{0}}{{r}_{0}^{2}} t = {k}_{j}^{′} t$$

By substituting the solved value for b as 0.002882, the justified model is expressed as:

$$t = \frac{{( 1 - {( 1 - α )}^{\frac{1}{3}} )}^{2}}{0.002882 {C}_{0}}$$

The form for reacted fraction a can be solved mathematically:

$$α = {( {( {k}_{j}^{′} t )}^{3} + 6 {( {k}_{j}^{′} t )}^{2} + 9 {k}_{j}^{′} t )}^{\frac{1}{2}} - 3 {k}_{j}^{′} t$$

where kⱼ′=0.002882×C₀.

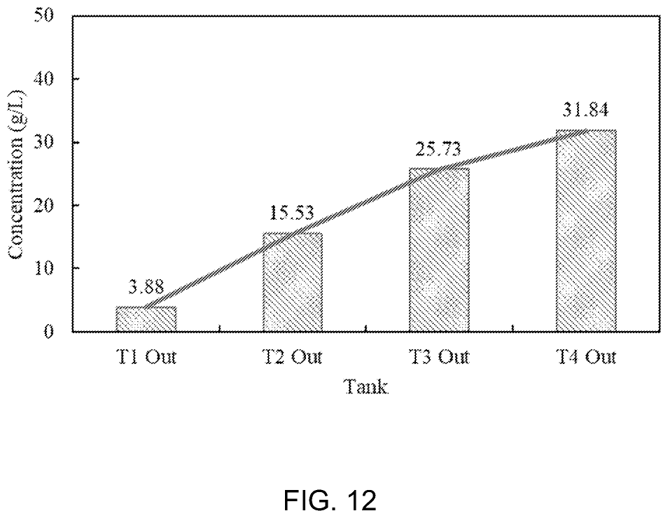

To further demonstrate the concept of CCL in CSTR reactors in this embodiment, experimental data was adopted and plotted into the justified model. The resulted Cu concentration (g/L) after each stage of leaching estimated by the justified model is shown in FIG. 12. As shown, when started with approximately 35 g/L Cu(II) and 5 g/L Cu(I) from the EW return, the stabilized final Cu(II) concentration when reaching steady-state in the CSTR was about 32 g/L. Likewise, after each stage of leaching, the final concentration of Cu(II) gradually decreased, eventually to about 4 g/L when leaving the leaching circuit for EW. Indicated by this trend, there should be a change on the rate constant k, corresponding to the change of Cu(II) concentration. In other words, the predicted model is changed from a higher concentration to a lower concentration one when transferring from tank to tank.

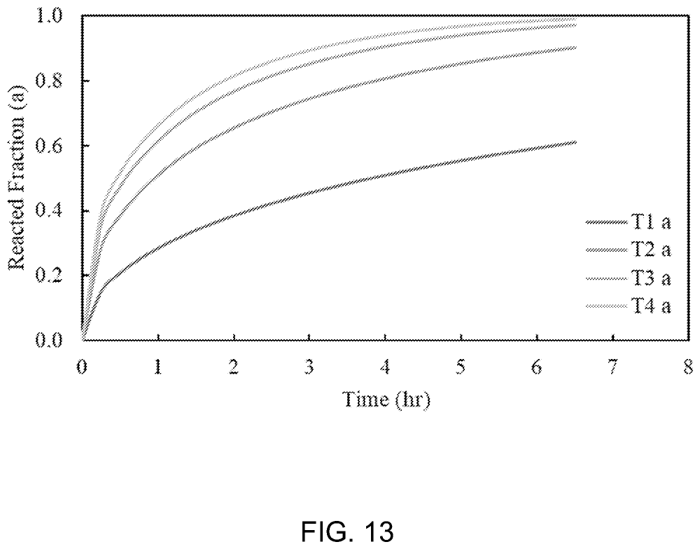

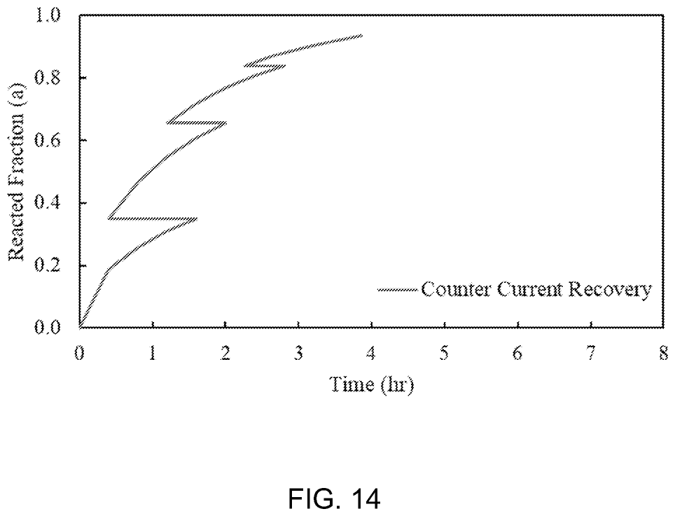

In the CCL circuit, starting from Tank 1, the solid is the most intact and the lixiviant is the most depleted in the oxidizer. In this case, the predicted value for reacted fraction a in Tank 1 is determined by the constant concentration model where the initial reactant concentration is 4 g/L, as shown in FIG. 13 (bottom curve corresponding to T1). Note that the retention time in Tank 1 is 1.6 hours as sufficient to achieve the same recovery as in the next leaching tank. Subsequently, in Tank 2, the started concentration fell in the next-to-bottom curve, under an in-tank concentration of 16 g/L. Similarly, in Tank 4, which is the beginner tank with highest concentration of Cu(II) and the last tank with most diluted Cu(0) in solid, the predicted model therefore fits in the later retention time of the top curve. In fact, the operation manner in CCL circuit resulted in a “zig-zag” shape of leaching curve, where the a corresponds to two different times when the solid changes tanks which have two different concentrations, as shown in FIG. 14.

Applying the following input parameters (as listed in Table B) for a CCL circuit using CSTR, accumulative reacted fraction a was obtained and listed in C. Note that a significant change in the inputs is the rate coefficient, now held as a variable differed by concentrations from tank to tank. The radius of free particles is 1 mm (top size of 2 mm), and the reaction takes place under ambient temperature. The starting lixiviant, composing 35 g/L Cu(II) and 5 g/L Cu(I), enters the CCL circuit at Tank 4, at a flow rate of 500 L/min. The pulp density is 10%. The solid phase, containing 30% wt. of Cu(0), flows through the circuit from Tank 1 at a mass flowrate of 3.33 t/h for total solid, and 1 t/h for Cu(0), respectively. The estimated reaction fraction a listed in Table C, showed a depleting trending for Cu(II) from Tank 4 (most concentrated) to Tank 1 (most depleted). The cumulative a at the end of leaching was 0.97 (97% Cu recovery).

TABLE B
Input parameters for process simulation using the justified model.

| Input | Symbol | Value | Unit |
|---|---|---|---|
| Rate coefficient (variable) | k′ | 0.002882 × C₀ | Unitless |
| Feed particle size | R | 1 | mm |
| Leaching temperature | T | 20 | ° C. |
| Initial Cu(II) concentration | Cu(II) | 35 | g/L |
| in solution | | | |
| Initial Cu(I) concentration | Cu(I) | 5 | g/L |
| in solution | | | |
| Initial Cu(0) concentration | Cu(0) | 30 | % wt. |
| in feed | | | |
| Lixiviant flow rate | Qₗᵢₓ | 500 | L/min |
| Mass flow of feed | Q_{feed} | 3.33 | t/h |
| Mass flow of Cu(0) | Q_{Cu(0)} | 1 | t/h |
| Total Residence time | | 6.4 | h |

TABLE C
Calculated α in each leaching tank by the justified model.

| Tank # | Time (hr) | [Cu²⁺]ₒᵤₜ (g/L) | Cumulative α |
|---|---|---|---|
| Tank 1 | 1.6 | 3.88 | 0.35 |
| Tank 2 | 3.2 | 15.53 | 0.66 |
| Tank 3 | 4.8 | 25.73 | 0.84 |
| Tank 4 | 6.4 | 31.84 | 0.93 |

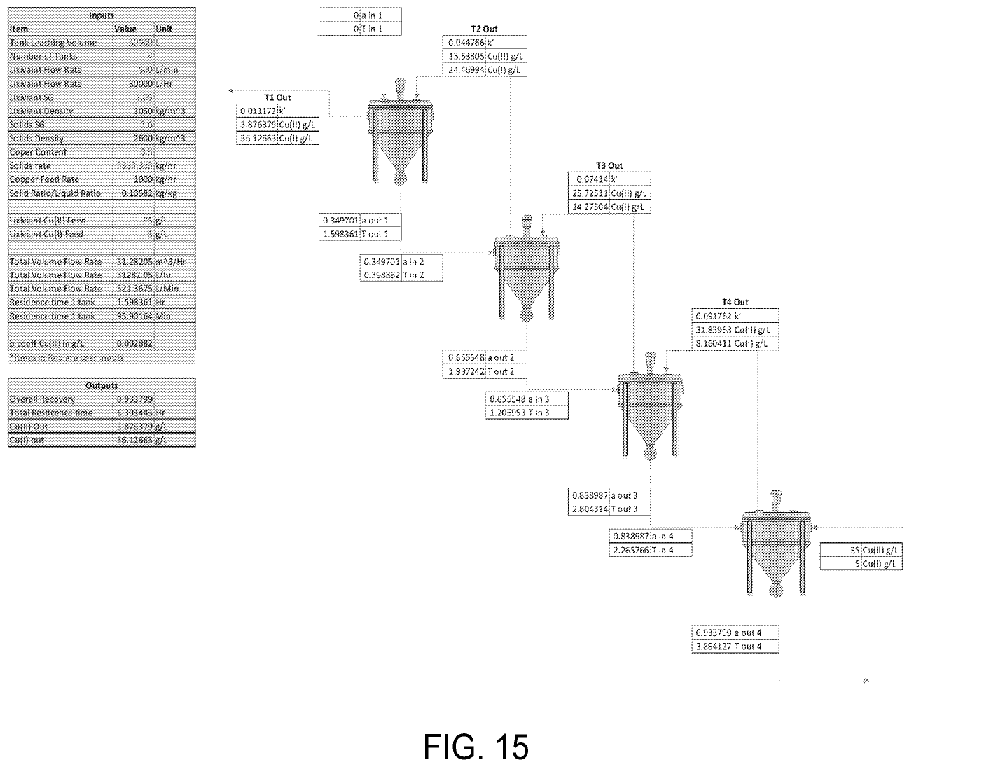

The estimated a were then programmed in a mass-balanced flowsheet, as shown in FIG. 15. As presented, the fresh lixiviant composing about 40 g/L Cu(II) and 5 g/L Cu(I) enters the leaching circuit from Tank 4. The waste PCBs, containing 30% wt. of Cu(0), is fed into the circuit from Tank 1, with 0 fraction reacted. The reacted solids in Tank 1 are then transferred to Tank 2, where the Cu(II) concentration is higher. By the time the materials reached Tank 4, the remaining Cu(0) is already very low. As it hits the highest Cu(II) concentration of 32 g/L, the residual Cu(0) is readily extracted in such concentrated solution, improving the total recovery from 89% in batch leaching circuit to 93% in CCL circuit. At the end, the PLS. consisting of 4 g/L of Cu(II) and 36 g/L of Cu(I), enters the EW, where the current efficiency is benefited from the Cu(II)-depleted and Cu(I)-enriched solution.

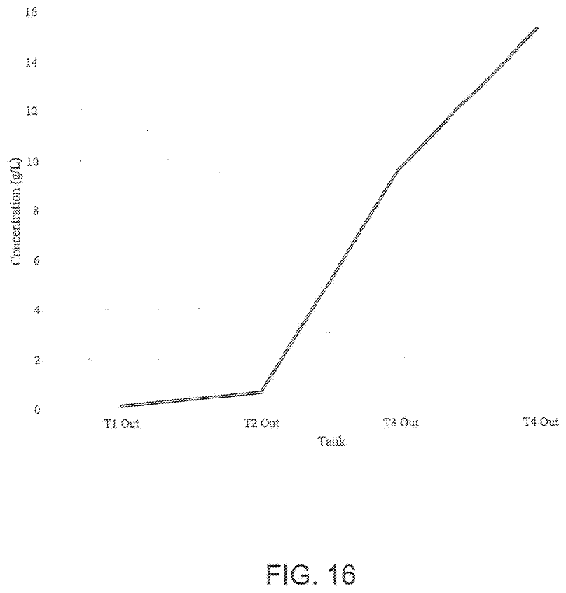

In function, there exists an infinitely large number of combinations of feed, concentrations, and residence times to provide satisfactory recoveries of metals and reagent consumption. As an additional non limiting embodiment, the simulation above was changed to a feed of 20 g/L of Cu(II) with the output resulting in shown in FIG. 16. Note that the overall residence time is the same, the Cu(II) at output being 0.91 g/L and the recovery dropping to 77%.

With regard to the practitioner being able to achieve such results as described herein, what may be non-obvious to those skilled in the art is how to achieve in practical terms the operation of a leaching circuit to achieve the simultaneous consumption of reagent with regards to minimizing the outgoing reagent. To provide a non-limiting embodiment demonstrating the techniques to achieve counter current solids residence time and liquid concentration of reagent, the following is provided.

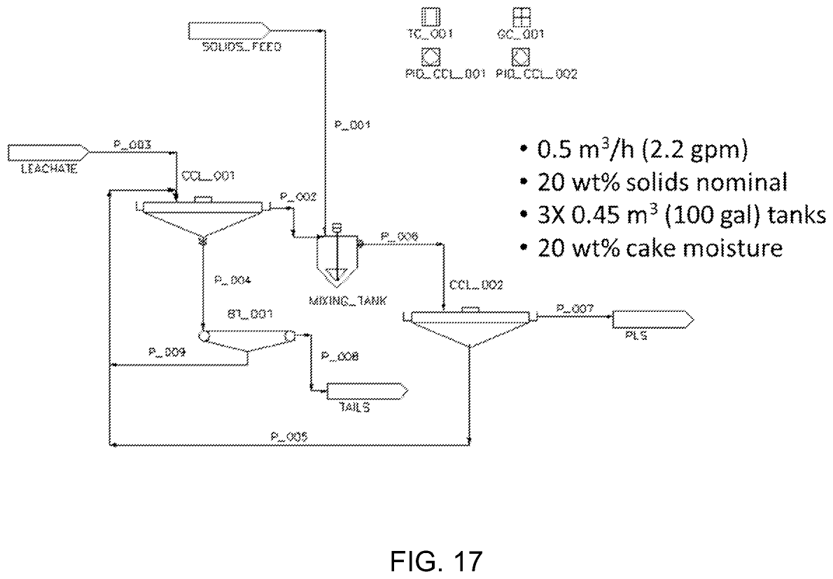

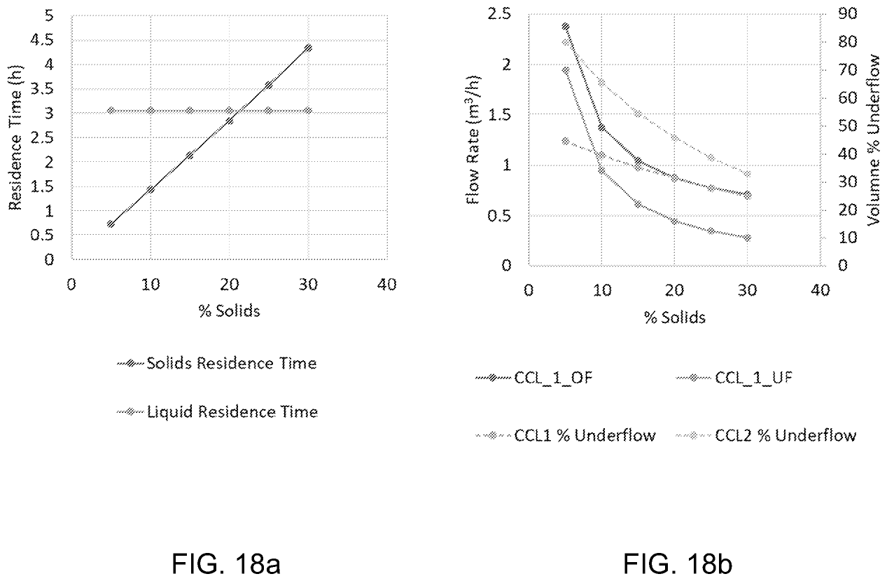

Utilizing a lamella clarifier as previously described, a 100 gallon vessel was feed a liquid 0.5 m²/hr. It can be assumed that the clarifier is of sufficient design to allow the solid/liquid separation under the range of conditions outlined. A circuit was arranged according to FIG. 17 with a 20 wt % moisture content from the underflow of the lamella clarifiers and a 20 wt % feed equivalent to the leachate to solids feed. FIGS. 18a and 18b shows the results where the residence time of the liquid is constant, based upon the tank size and the infeed rate of the leachate the solid underflow rate. Thus, as shown in these figures (FIG. 18a) that the residence time of the solid (FIG. 18b) is determined by the transfer rate (underflow) of the solid containing phase counter to the liquid phase. The solid residence time, and % solids in the tank is determined by the tank size and the solid phase advancement rate. The overflow design of the lamella clarifiers provides balance to the remaining liquid phase. In this manner those skilled in the art may utilize the lamella clarifier to achieve the requisite liquid flow rate and solids residence time required for the recover described in previous embodiments.

As a further embodiment, methods of measurement and control may be, UV-Vis for Cu(II), ORP measurements corresponding to Cu(II)/Cu(I) ratios, or direct measurement by titration for assaying for lixiviant measurement. In this manner, the control of the leaching circuit may be conducted.

This disclosure may be considered to relate to the following items:
1. A method of recovering a target metal from a feed material, comprising:
   contacting the feed material with a lixiviant adapted to leach the target metal from a feed material feed stream in a leaching circuit having a plurality of leaching vessels V₁, V₂, Vₙ in series;
   establishing a countercurrent flow in the leaching circuit by delivering the feed material feed stream to the leaching vessel V₁ and moving the feed material feed stream through the leaching circuit in a first direction toward leaching vessel Vₙ and delivering the lixiviant to the leaching vessel V₁ and moving the lixiviant through the leaching circuit in a second direction toward leaching vessel V₁;
   determining, by a controller, a reagent consumption rate for each of the leaching vessels V₁, V₂, Vₙ so as to validate performance, minimize left over reagent discharged from leaching vessel V₁ and maximize target metal recovery from leaching vessel Vₙ; and recovering the target metal from the lixiviant.
2. The method of item 1, further including calculating, by the controller, the reagent consumption rate for each vessel V₁, V₂, Vₙ based upon a formula (C_{n,in}−C_{n,out})/C_{n,in}*100 where C_{n,in} is a concentration of the reagent entering the vessel and Cₒᵤₜ is the concentration of the reagent leaving the vessel.
3. The method of item 1, further including using an ammonia-based lixiviant.
4. The method of item 1, further including using copper (II) (Cu(II)) as an oxidizer and the reagent.
5. The method of item 1, further including using an ammonia-based lixiviant and using copper (II) (Cu(II)) as an oxidizer and the reagent.
6. The method of any of items 1-5, further including determining, by the controller, a residence time for the feed material feed stream in each vessel V₁, V₂, Vₙ based upon an average particle size of the feed material feed stream.
7. The method of item 6, further including conducting the leaching under anaerobic conditions.
8. The method of item 7, further including using electronic waste as the feed material and selecting copper metal as the target metal.
9. The method of item 8, further including using electrowinning in the recovering of the copper metal from the lixiviant.
10. The method of item 9, including generating Cu(II) ions during electrowinning and using the generated Cu(II) ions as an oxidant for leaching the copper metal in the leaching circuit.
11. The method of any of items 1-5, further including conducting the leaching under anaerobic conditions.
12. The method of item 11, further including using electronic waste as the feed material and selecting copper metal as the target metal.
13. The method of item 12, further including using electrowinning in the recovering of the copper metal from the lixiviant.
14. The method of item 13, including generating Cu(II) ions during electrowinning and using the generated Cu(II) ions as an oxidant for leaching the copper metal in the leaching circuit.
15. An apparatus for recovering a target metal from a feed material, comprising;
   a leaching circuit having a plurality of leaching vessels V₁, V₂, Vₙ in series; and
   a control module including:
   a metering system adapted for delivering the feed material feed stream to the leaching vessel V₁ and moving the feed material feed stream through the leaching circuit in a first direction toward leaching vessel Vₙ and delivering a liquid phase, including an ammonia-based lixiviant and a Cu(II) reagent, to the leaching vessel Vₙ and moving the liquid phase through the leaching circuit in a second direction toward leaching vessel V₁;
   a plurality of Cu(II) concentration monitors adapted for monitoring the concentration of Cu(II) in each of the leaching vessels V₁, V₂, Vₙ in the leaching circuit and collecting data respecting the concentration of Cu(II) in each of the leaching vessels V₁, V₂, Vₙ in the leaching circuit; and
   a controller adapted to receive the data from the plurality of Cu(II) concentration monitors and maintain the concentration of the copper II (Cu(II)) in the ammonia-based lixiviant in the leaching vessels V₁, V₂, Vₙ by changing the flow rate of the liquid phase, and/or the flow rate of the feed material feed stream to achieve metal removal from the feed material feed stream of between 1 and 50% in each vessel.
16. The apparatus of item 15 wherein the controller is further adapted to calculate the Cu(II) reagent consumption in each vessel V₁, V₂, Vₙ in accordance with a formula (C_{n,in}−C_{n,out})/C_{n,in}*100 where C_{n,in} is a concentration of the Cu(II) reagent entering the vessel and C_{n,out} is the concentration of the Cu(II) reagent leaving the vessel.
17. The apparatus of item 16, further including a shredding device, adapted for shredding the feed material to an average particle size of less than 10 mm, upstream from the leaching vessel V₁.
18. The apparatus of item 17, further including an electrowinning device, adapted to recover copper metal from the ammonia-based lixiviant and generate Cu(II) ions for use as an oxidant for leaching the copper metal in the leaching circuit, downstream from leaching vessel V₁.
19. The apparatus of any of items 15-18, wherein the leaching vessels V₁, V₂, and Vₙ are lamella clarifiers with agitation.

Each of the following terms: “includes”, “including”, “has”, “having”, “comprises”, and “comprising”, and, their linguistic/grammatical variants, derivatives, or/and conjugates, as used herein, means “including, but not limited to”, and is to be taken as specifying the stated component(s), feature(s), characteristic(s), parameter(s), integer(s), or step(s), and does not preclude addition of one or more additional component(s), feature(s), characteristic(s), parameter(s), integer(s), step(s), or groups thereof.

The term “method”, as used herein, refers to steps, procedures, manners, means, or/and techniques, for accomplishing a given task including, but not limited to, those steps, procedures, manners, means, or/and techniques, either known to, or readily developed from known steps, procedures, manners, means, or/and techniques, by practitioners in the relevant field(s) of the disclosed invention.

Terms of approximation, such as the terms about, substantially, approximately, etc., as used herein, refers to: ±10% of the stated numerical value. Use of the terms parallel or perpendicular are meant to mean approximately meeting this condition, unless otherwise specified.

It is to be fully understood that certain aspects, characteristics, and features, of the method of recovering metals from waste material, which are, for clarity, illustratively described and presented in the context or format of a plurality of separate embodiments, may also be illustratively described and presented in any suitable combination or sub-combination in the context or format of a single embodiment. Conversely, various aspects, characteristics, and features, of the method which are illustratively described and presented in combination or sub-combination in the context or format of a single embodiment may also be illustratively described and presented in the context or format of a plurality of separate embodiments.

The foregoing has been presented for purposes of illustration and description. It is not intended to be exhaustive or to limit the embodiments to the precise form disclosed. Obvious modifications and variations are possible in light of the above teachings. For example, the apparatus may be arranged so that the solid phase/feed material is maintained in a single vessel throughout processing but the liquid phase is manipulated in a manner to approximate a countercurrent flow. Further, illustrated embodiments refer to shredding of the waste material prior to processing. Other alternative or additional methods of preparing the waste material for processing include but are not limited to sizing the waste material by means other than shredding, removing ferro-magnetic materials by pretreatment with a magnet, pretreatment by eddy-current or sensor sorting and the like. All such modifications and variations are within the scope of the appended claims when interpreted in accordance with the breadth to which they are fairly, legally and equitably entitled.

1. A method of recovering a target metal from a feed material, comprising:
contacting the feed material with a lixiviant adapted to leach the target metal from a feed material feed stream in a leaching circuit having a plurality of leaching vessels (at least greater than two) V₁, V₂, Vₙ in series;
establishing a countercurrent flow in the leaching circuit by delivering the feed material feed stream to the leaching vessel V₁ and moving the feed material feed stream through the leaching circuit in a first direction toward leaching vessel Vₙ and delivering the lixiviant to the leaching vessel Vₙ and moving the lixiviant through the leaching circuit in a second direction toward leaching vessel V₁;
determining, by a controller, a reagent consumption rate for at least one of the leaching vessels V₁, V₂, Vₙ so as to validate performance, minimize left over reagent discharged from leaching vessel V₁ and maximize target metal recovery from leaching vessel Vₙ; and
recovering the target metal from the lixiviant.

2. The method of claim 1, further including calculating, by the controller, the reagent consumption rate for each vessel V₁, V₂, Vₙ based upon a formula (C_{n,in}−C_{n,out})/C_{n,in}*100 where C_{n,in} is a concentration of the reagent entering the vessel and C_{n,out} is the concentration of the reagent leaving the vessel.

3. The method of claim 1, further including using an ammonia-based lixiviant.

4. The method of claim 1, further including using copper (II) (Cu(II)) as an oxidizer and the reagent.

5. The method of claim 1, further including using an ammonia-based lixiviant and using copper (II) (Cu(II)) as an oxidizer and the reagent.

6. The method of claim 1, further including determining, by the controller, a residence time for the feed material feed stream in each vessel V₁, V₂, Vₙ based upon an average particle size of the feed material feed stream.

7. The method of claim 6, further including conducting the leaching under anaerobic conditions.

8. The method of claim 7, further including using electronic waste as the feed material and selecting copper metal as the target metal.

9. The method of claim 8, further including using electrowinning in the recovering of the copper metal from the lixiviant.

10. The method of claim 9, including generating Cu(II) ions during electrowinning and using the generated Cu(II) ions as an oxidant for leaching the copper metal in the leaching circuit.

11. The method of claim 1, further including conducting the leaching under anaerobic conditions.

12. The method of claim 11, further including using electronic waste as the feed material and selecting copper metal as the target metal.

13. The method of claim 12, further including using electrowinning in the recovering of the copper metal from the lixiviant.

14. The method of claim 13, including generating Cu(II) ions during electrowinning and using the generated Cu(II) ions as an oxidant for leaching the copper metal in the leaching circuit.

15. An apparatus for recovering a target metal from a feed material, comprising;
a leaching circuit having a plurality of leaching vessels V₁, V₂, Vₙ in series; and
a control module including:
a metering system adapted for delivering the feed material feed stream to the leaching vessel V₁ and moving the feed material feed stream through the leaching circuit in a first direction toward leaching vessel Vₙ and delivering a liquid phase, including an ammonia-based lixiviant and a Cu(II) reagent, to the leaching vessel Vₙ and moving the liquid phase through the leaching circuit in a second direction toward leaching vessel V₁;
at least one Cu(II) concentration monitor adapted for monitoring the concentration of Cu(II) in at least one of the leaching vessels V₁, V₂, Vₙ in the leaching circuit and collecting data respecting the concentration of Cu(II) in each of the leaching vessels V₁, V₂, Vₙ in the leaching circuit; and
a controller adapted to receive the data from at least one Cu(II) concentration monitor and maintain the concentration of the copper II (Cu(II)) in the ammonia-based lixiviant in the leaching vessels V₁, V₂, Vₙ by changing the flow rate of the liquid phase, and/or the flow rate of the feed material feed stream to achieve metal removal from the feed material feed stream of between 1 and 50% in each vessel.

16. The apparatus of claim 15 wherein the controller is further adapted to calculate the Cu(II) reagent consumption in each vessel V₁, V₂, Vₙ in accordance with a formula (C_{n,in}−C_{n,out})/C_{n,in}*100 where C_{n,in} is a concentration of the Cu(II) reagent entering the vessel and C_{n,out} is the concentration of the Cu(II) reagent leaving the vessel.

17. The apparatus of claim 16, further including a shredding device, adapted for shredding the feed material to an average particle size of less than 10 mm, upstream from the leaching vessel V₁.

18. The apparatus of claim 17, further including an electrowinning device, adapted to recover copper metal from the ammonia-based lixiviant and generate Cu(II) ions for use as an oxidant for leaching the copper metal in the leaching circuit, downstream from leaching vessel V₁.

19. The apparatus of claim 15, wherein the leaching vessels V₁, V₂, and Vₙ are lamella clarifiers with agitation.
